(19) United States
(12) Patent Application Publication
(10) Pub. No.: US 2008/0230168 A1
(43) Pub. Date: Sep. 25, 2008

(54) LAMINATOR AND LAMINATING METHOD

(75) Inventors: YING-SONG WEN, Shenzhen (CN); KAI LIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 11/857,375

(22) Filed: Sep. 18, 2007

(30) Foreign Application Priority Data
Mar. 23, 2007 (CN) 200710073642.4

(51) Int. Cl. B32B 41/00

(52) U.S. Cl. 156/64; 156/378

(57) ABSTRACT

A laminator is configured for laminating a film sheet on a respective surface of a plurality of substrates. The laminator includes a pressure roller, a first conveyance device, a second conveyance device, and a distance measuring system. The first conveyance device is provided for controllably conveying substrates to the pressure roller. The second conveyance device is provided for controllably conveying substrates to the first conveyance device. The distance measuring system is provided for measuring a space between the substrate on the first conveyance device and the sequential substrate on the second conveyance device, adjacent to the first substrate.

### BACKGROUND OF THE INVENTION

1. Field of the Invention

The present invention relates to apparatus for manufacturing printed circuit boards and, particularly, to a laminator and a laminating method for laminating a film on a surface of a substrate.

2. Description of Related Art

With the development of science and technology, items such as microphones, portable computers, electronic products used in cars, portable electronics, and the like require ever greater levels of miniaturization and weight reduction. To meet these requirements, the degree of circuit integration is increasing, with a concordant increase in density of circuit patterns. As part of the increase circuitry density, the width of traces, the gaps between traces, and the diameter of via holes are becoming finer/smaller. To accommodate these developments in the art, flexible printed circuit boards have been developed.

Typical flexible printed circuit boards include base films and copper films disposed on the two opposite surfaces of the base films. Conductive traces are disposed in the copper films. Via holes pass through at least one copper film, and a given base film functions to electrically connect the conductive traces disposed on the two opposite copper films. Via holes are comprised, in sum, of copper holes in the copper films and film holes in the base films.

A typical method for forming the flexible printed circuit boards is by an etching process using a dry film photoresist. For example, in forming copper holes, the etching process generally includes the steps of: firstly, providing a copper coated substrate, which includes a base film and a copper film coated onto one surface of the base film; and secondly, pressing a dry film photoresist onto the copper film and exposing it with a plastic photomask, which has a desired pattern. After exposure, part of the dry film photoresist can be dissolved, while residual insoluble portions of the dry film photoresist form the desired patterns. Thirdly, the dry film photoresist is developed with a developing agent to remove the soluble portions of the dry film photoresist, while the residual portions covering the copper films protects the copper films from corrosion. Following such step, the desired pattern is formed, and the undesired parts of the copper film are left uncovered. Finally, the undesired parts of the copper film are etched to obtain a number of copper holes. At this point, parts of the base film corresponding to the copper holes are exposed. The residual dry film is then removed, and the exposed portions of the base film are then etched to form film holes in the base film.

In the above conventional method of laminating the photo-resist film on the surface of the flexible printed circuit board, the flexible printed circuit boards are manually conveyed to the laminating device. Therefore, distances between adjacent flexible printed circuit boards may not be easily controlled. In a continuous laminating process, in one possible circumstance, the distance between adjacent flexible printed circuit boards may be too long, and thus a rather significant amount of the photo-resist film may be wasted due to the long distance between the adjacent flexible printed circuit boards. In another possible circumstance, the distance between adjacent flexible printed circuit boards may be too short, and thus a sequential flexible printed circuit board may affect or impact a preceding flexible printed circuit board in the laminating process.

What is needed, therefore, is a laminator and a laminating method to facilitate effective lamination of flexible printed circuit boards.

### SUMMARY OF THE INVENTION

The following pertains to a laminator for laminating a film sheet on a respective surface of a plurality of substrates. The laminator includes a pressure roller, a first conveyance device, a second conveyance device, and a distance measuring system. The first conveyance device is provided for controllably conveying substrates to the pressure roller. The second conveyance device is provided for controllably conveying substrates to the first conveyance device. The distance measuring system is provided for measuring a space between the substrate on the first conveyance device and the sequential substrate on the second conveyance device, adjacent to the first substrate.

A method of laminating a film sheet on a respective surface of a plurality of substrates is also provided. The laminating method including the following steps:

employing a first conveyance device in order to controllably supply substrates to a pressure roller;
employing a second conveyance device, the second conveyance device thereby controllably conveying substrates to the first conveyance device;
predetermining/establishing a predetermined distance between a first substrate on the first conveyance device and a sequential substrate on the second conveyance device, the sequential substrate being adjacent to the first substrate on the first conveyance device;
using a distance measuring system in order to measure a distance between the first substrate on the first conveyance device and the sequential substrate on the second conveyance device; and
comparing the measured distance with the initial distance, and according to the compared result, employing a controller to regulate a conveying speed of the second conveyance device so as to maintain an actual distance between the first substrate on the first conveyance device and the sequential substrate on the second conveyance device within the predetermined distance range.

Advantages and novel features will become more apparent from the following detailed description when taken in conjunction with the accompanying drawings.

### BRIEF DESCRIPTION OF THE DRAWINGS

Many aspects of the present laminator and laminating method can be better understood with reference to the following drawings. The components in the drawings are not necessarily drawn to scale, the emphasis instead being placed upon clearly illustrating the principles of the present laminator and laminating method. Moreover, in the drawings, like reference numerals designate corresponding parts throughout the several views.

FIG. 1 is an isometric view of a laminator, in accordance with a first present embodiment; and

FIGS. 2A-2D are schematic views of a laminating method, in accordance with a second present embodiment.

### DETAILED DESCRIPTION OF THE INVENTION

Reference will now be made to the drawings to describe the embodiments of the present laminator and laminating method, in detail.

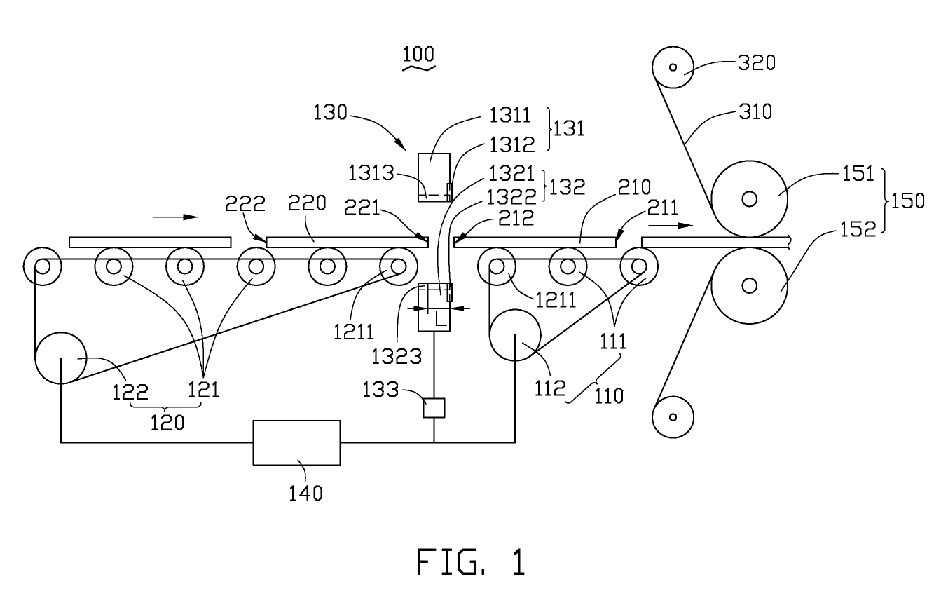

Referring to FIG. 1, a laminator 100 for laminating a film on a respective surface of a plurality substrates, in accordance with a first present embodiment, is illustrated. The laminator 100 includes a first conveyance device 110, a second conveyance device 120, a distance measuring system 130, a controller 140, and a pressure roller 150. The first conveyance device 110 is provided and particularly configured (i.e., structured and arranged) to supply/carry a substrate to the pressure roller 150. The second conveyance device 120 is provided and particularly configured to supply/carry a substrate to the first conveyance device 110. The distance measuring system 130 is applied to measure a distance between the substrate on the first conveyance device 110 and the sequential substrate on the second conveyance device 120. The controller 140 advantageously controls a conveying/transporting speed of the first conveyance device 110 and of the second conveyance device 120 and also manages the operation of the distance measuring system 130. In the present embodiment, the laminator 100 is used to laminate a photo-resist film on a flexible printed circuit board (FPCB). However, it is to be understood that other products could be laminated using the laminator 100 and still be within the scope of the present embodiment.

The second conveyance device 120, the first conveyance device 110, and the pressure roller 150 are arranged in a row, along a conveyance direction of FPCBs to be processed. In this case, the numbering of the conveyance device 110, 120 is chosen in accordance with the processing order, as opposed to a left-to-right sequence. In a laminating process, the substrate (e.g., a first FPCB 210) on the first conveyance device 110 will be firstly conveyed/transported to the pressure roller 150 and be processed, then the conveying/transporting and processing of the sequential substrate (e.g., a second FPCB 220) on the second conveyance device 120 follows. A distance between the first conveyance device 110 and the second conveyance device 120, and a distance between the second conveyance device 120, and the pressure roller 150 are, separately, less than a length of any FPCB to be processed. Thus, the FPCBs to be processed can be, continuously, transferred among the pressure roller 150, the first conveyance device 110, and the second conveyance device 120.

The first conveyance device 110 includes at least a first roller 111 and at least a first rotational driving element 112. For example, the first conveyance device 110 includes a number of first rollers 111 driven by one first rotational driving element 112. The first rollers 111 carry and convey the FPCBs to be processed. The first rotational driving element 112 is controlled by the controller 140 to drive the first roller 111 to rotate. Due to such rotation, the FPCBs carried on the first rollers 111 can be transferred/transported from one end of the first conveyance device 110 to the other end, until the FPCBs are conveyed to the pressure roller 150. The first rotational driving element 112 may be controlled to drive the first rollers 111 to rotate with a uniform speed or with variable speeds. Therefore, the FPCBs to be processed carried on the first rollers 111 may, thus, be transferred at a uniform speed or at variable speeds. In the present embodiment, the first conveyance device 110 conveys the FPCBs with a uniform conveying speed. In order to achieve a stable laminating process, a laminating speed of the pressure roller 150 is consistent with the conveying speed of the first conveyance device 110.

The second conveyance device 120 includes at least a second roller 121 and at least a second rotational driving element 122. For example, the second conveyance device 120 includes a number of second rollers 121 driven by one second rotational driving element 122. The second rollers 121 carry and convey the FPCBs to be processed. The second rotational driving element 122 is controlled by the controller 140 to drive the second roller 121 to rotate. As a product of that rotation, the FPCBs to be processed, which are carried on the second rollers 121, may be transferred from one end of the second conveyance device 120 to the other end, until the FPCBs are conveyed to the first conveyance device 110. The second rotational driving element 122 may, usefully, be controlled to drive the second rollers 121 to rotate with a uniform speed or with variable speeds. Therefore, the FPCBs to be processed carried on the second rollers 121 may be transferred at a uniform speed or at variable speeds. In order to keep a required spacing between adjacent FPCBs, the conveying speed of the second conveyance device 120 and the first conveyance device 110 need to be controlled, in accordance to a given condition. In a beneficial embodiment, the first conveyance device 110 conveys the FPCBs at a constant speed, and the conveying speed of the second conveyance device 120, controlled by the controller 140, can be adjusted to achieve a constant value of the distance between the FPCB on the first conveyance device 110 and the sequential FPCB on the second conveyance device 120.

The distance measuring system 130 is provided and configured to measure a space (i.e., separation distance) between the FPCB on the first conveyance device 110 and the sequential FPCB on the second conveyance device 120 while such FPCBs are in motion. In order to easily describe the distance to be measured, a first FPCB 210 and a second FPCB 220 are defined. Specifically, the distance to be measured is a distance between a front end 221 of the second FPCB 220 and a back end 212 of the first FPCB 210. The distance measuring system 130 is positioned near a transition region where a given FPCB transits/transfers between the first conveyance device 110 and the second conveyance device 120. The distance measuring system 130 may be controlled, e.g., controlled by the controller 140, to measure the space between the front end 221 and back end 212. The distance measuring system 130 is usefully electrically/electronically connected (e.g., hard-wired or wireless) to the controller 140 and may be driven by a driving apparatus 133. The driving apparatus 133 may, usefully, be a movable frame. For example, the movable frame includes a bracket configured for supporting the distance measuring system 130 and at least a roller structured and arranged for driving the bracket to move. The controller 140 connects the roller of the movable frame to adjust the rotation of the roller, thereby regulate the movement of the movable frame, and further manage the motion of the distance measuring system 130. Thus, the distance measuring system 130 can move together with the movement of the first and second FPCBs 210 and 220, thereby, instantly measure the space between the front end 221 and the back end 212.

The distance measuring system 130 includes an emitter 131 and an oppositely-arranged acceptor 132. The emitter 131 is arranged on a side of the FPCB to be conveyed, and the acceptor 132 is arranged on the other side of the FPCB to be conveyed. Usefully, the emitter 131 and the acceptor 132 are positioned perpendicular to the FPCB to be conveyed and, as such, are at opposite sides of the conveyance path of the laminator 100.

The emitter 131 includes a first measuring unit 1311 and a first detecting unit 1312. The acceptor 132 includes a second measuring unit 1321 corresponding to the first measuring unit 1311 and a second detecting unit 1322 corresponding to the first detecting unit 1312. The first detecting unit 1312 and the second detecting unit 1322 cooperate to detect a starting point of the distance measurement process of the distance measuring system 130. Thus, the subsequent measurement process can be performed accurately. Once the detected starting point satisfies a predetermined requirement, the first measuring unit 1311 and the second measuring unit 1321 cooperate to measure a space between the front end 221 of the second FPCB 220 and a back end 212 of the first FPCB 210.

An example of a measurement process of the distance measuring system 130 is described in the following. Firstly, the distance measuring system 130 is fixed, and the first FPCB 210 and the second FPCB 210 are transferred on the second conveyance device 120. Then, the distance measuring system 130, the controller 140, and the pressure roller 150 are started up. In a working state of the distance measuring system 130, the first detecting unit 1312 emits light beams towards the second detecting unit 1322 and the second detecting unit 1322 receives the light beams from the first detecting unit 1322.

Secondly, the starting point is detected. As the first FPCB 210 enters in the transition region between the second conveyance device 120 and the first conveyance device 110. More specifically, a front end 211 of the first FPCB 210 arrives at the first conveyance device 110, and then the light beams from the first detecting unit 1312 to the second detecting unit 1322 can be interrupted by the transiting first FPCB 210. In this instance, the second detecting unit 1322 cannot receive the light beams. Subsequently, the first FPCB 210 is transferred continuously. As the back end 212 of the first FPCB 210 arrives at the first conveyance device 110, at the same time, the front end 221 of the sequential second FPCB 220 is not in the transition region. In this instance, the light beams from the first detecting unit 1312 to the second detecting unit 1322 cannot be interrupted, as the transition region has no any transiting FPCB therein. Therefore, the second detecting unit 1322 receives the light beams. In summary, the second detecting unit 1322 can receive continuous light beams and discontinuous light beams. The desired starting point may be a turning point of a transition, from the continuous-light-beam-receiving point to the discontinuous-light-beam-receiving point, or the turning point of a transition from the discontinuous-light-beam-receiving point to the continuous-light-beam-receiving-point.

Thirdly, at the detected starting point, the first measuring unit 1311 and the second measuring unit 1321 cooperate to measure a distance between the front end 221 of the second FPCB 220 and a back end 212 of the first FPCB 210.

Advantageously, the first measuring unit 1311 includes a signal emitting groove 1313 (i.e., a groove through and out of which emitted signals are channeled upon emission/generation; that is, the groove is not the emission source, per se), adjacent to the first detecting unit 1312. The signal emitting groove 1313 is created in the first measuring unit 1311 and is directed toward and along (i.e., essentially parallel to) the transferring direction of the FPCBs. Similarly, the second measuring unit 1321 includes a signal accepting groove 1323, adjacent to the second detecting unit 1322. The signal accepting groove 1323 is created in second measuring unit 1321, corresponding to the signal emitting groove 1313 of the first measuring unit 1311. After the first detecting unit 1312 and the second detecting unit 1322 cooperate to detect the above-described starting point of the distance measurement process of the distance measuring system 130, a distance measuring signal is initiated by the emitter 131 and emits out of the signal emitting groove 1313, and, at the same time, the signal accepting groove 1323 begins to receive the distance measuring signal from the signal emitting groove 1313.

The controller 140 is used to control the various apparatus elements electrically/electronically connected (e.g., hard-wired or wireless) thereto. For example, the controller 140 may control movements of the first conveyance device 110, the second conveyance device 120, and the distance measuring system 130. In detail, the controller 140 electrically/electronically connects to the first rotational driving element 112, and, thus, the first rotational driving element 112 can controllably drive the first rollers 111 to convey the FPCBs thereon. For example, the first rollers 111 can be driven by the first rotational driving element 112 and thereby convey the FPCBs with a uniform speed or with a variable speed. Similarly, the controller 140 electrically/electronically connects to the second rotational driving element 122, and, thus, the second rotational driving element 122 can controllably drive the second rollers 121 to convey the FPCBs thereon. In another example, the second rollers 121 can be driven by the second rotational driving element 122 to convey the FPCBs with a uniform speed or with a variable speed. Regarding the distance measuring system 130, the emitter 131 and the acceptor 132 are connected together, whether the controller 140 electrically/electronically connects to the emitter 131 or connects to the acceptor 132, the distance measuring system 130 can be controlled to move. For example, the driving apparatus 133 includes a plane base, two brackets perpendicularly extending from one side of the plane base, and a number of rollers configured for driving the plane base to move. The emitter 131 and the acceptor 130 respectively connect to their corresponding bracket. Thus, the distance measuring system 130 can move together with the driving apparatus 133. However, it is to be understood that the distance measuring system 130 and the driving apparatus 133 may have other configurations, to realize the moving of the distance measuring system 130.

The pressure roller 150 includes a top pressure roller 151 and a bottom pressure roller 152. The FPCB, upon transfer from the first conveyance device 110, can be laminated between the top pressure roller 151 and the bottom pressure roller 152. Each of the top pressure roller 151 and the bottom pressure roller 152 is separately wrapped with a dry photo-resist strip 310. The dry photo-resist strip 310 may, advantageously, be disposed around a reel 320.

In a laminating process, the FPCBs to be processed are transferred from the second conveyance device 120 to the first conveyance device 110, and then are conveyed by the first conveyance device 110 to a predetermined position between the top pressure roller 151 and the bottom pressure roller 152. Subsequently, the dry photo-resist strip 310 around the top pressure roller 151 and the bottom pressure roller 152 are laminated on two sides surfaces of the FPCB, positioned between the top pressure roller 151 and the bottom pressure roller 152.

Alternatively, a heating apparatus may be provided to heat the top pressure roller 151 and the bottom pressure roller 152, and, thus, the dry photo-resist strip 310 and the FPCB to be processed can be laminated together at an appropriate temperature. It is to be understood that the top pressure roller 151 and the bottom pressure roller 152 themselves could be heated and/or respective separate, adjacent heating units could be provided to achieve the desired level of heating.

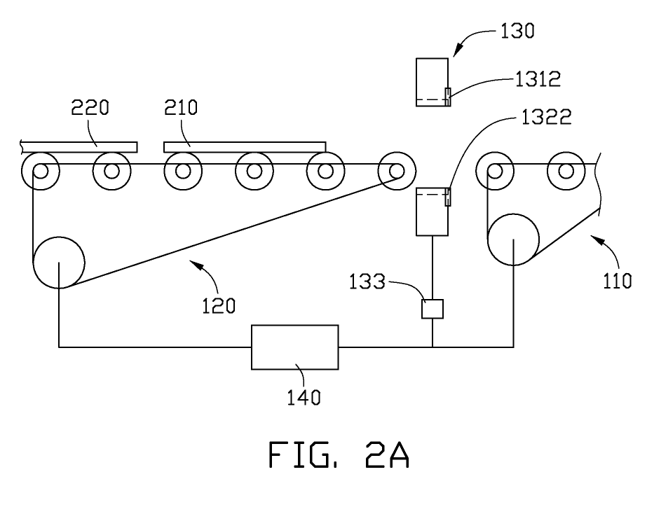

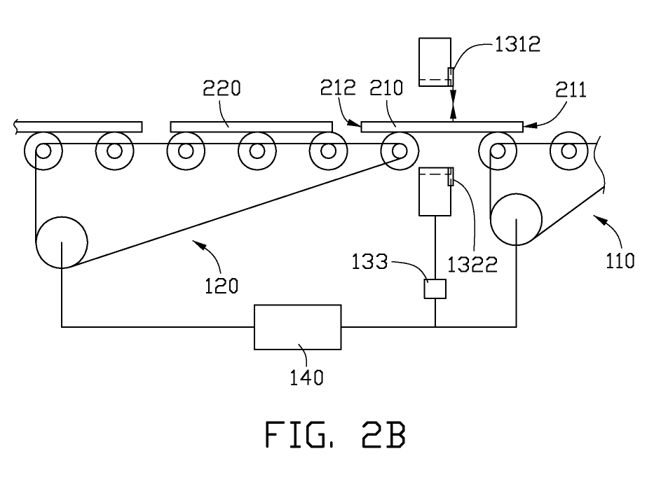

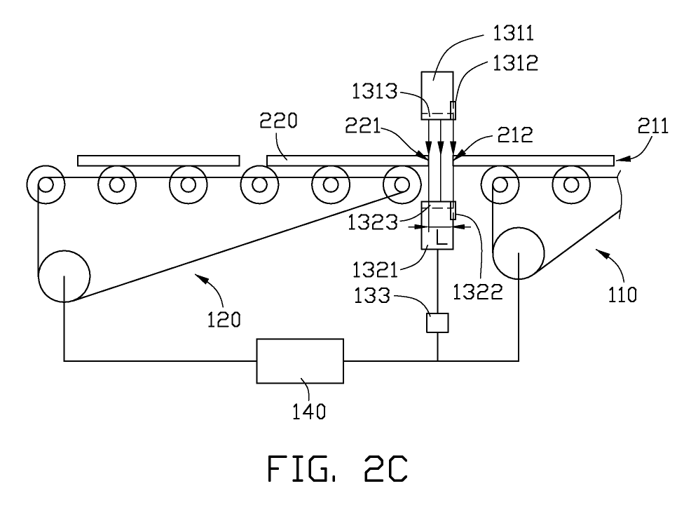

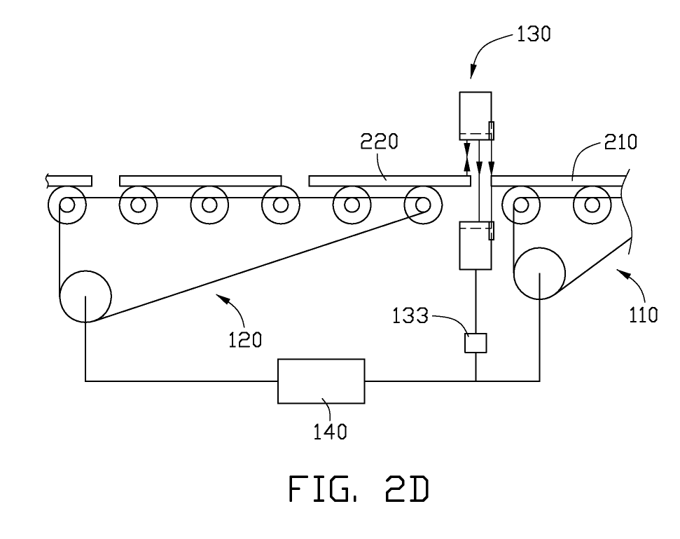

A method of laminating a film sheet on a respective surface of a plurality of substrates, in accordance with a second present embodiment, is described. The method comprising the steps of: employing a first conveyance device in order to supply substrates to a pressure roller; employing a second conveyance device in order to convey substrates to the first conveyance device; establishing a predetermined distance between a first substrate on the first conveyance device and a sequential substrate on the second conveyance device, the sequential substrate being adjacent to the first substrate on the first conveyance device; using a distance measuring system to measure a distance between the first substrate on the first conveyance device and the sequential substrate on the second conveyance device; and comparing the measured distance with the predetermined distance, and in accordance to the compared result, employing a controller to control a conveying speed of the second conveyance device to keep an actual distance between the first substrate on the first conveyance device and the sequential substrate on the second conveyance device within the predetermined distance range. For example, referring to FIGS. 2A to 2D, a method for laminating a photo-resist film on a surface of a FPCB is described in the following.

In a first step, the above-described laminator 100 with photo-resist film and a number of FPCBs are provided. Referring to FIG. 2A, the distance measuring system 130 is fixed between the second conveyance device 120 and the first conveyance device 110. The distance measuring system 130, the second conveyance device 120, and the first conveyance device 110 are instructed by the controller 140 begin to work. A plurality of FPCBs, e.g., the first FPCB 210 and the second FPCB 220, are transferred on the second conveyance device 120. In the present embodiment, the first conveyance device 110 begins to work at a uniform conveying speed v1, and the second conveyance device 120 begins to work at a conveying speed v2. A predetermined distance between the front end 221 of the second FPCB 220 and a back end 212 of the first FPCB 210 is in a range from about 2 millimeters to about 25 millimeters. A numerical value of an allowable error of the predetermined distance is in a range from minus one millimeter to plus one millimeter. Opportunely, an allowable of the predetermined distance has an absolute value in a range from about 0.1 millimeters to about 0.15 millimeters. In the present embodiment, the numerical value of the predetermined distance is represented with a symbol C.

In a second step, the starting point of the distance measurement process of the distance measuring system 130 is detected. Firstly, referring to FIG. 2B, the first FPCB 210 enters in the transition region between the second conveyance device 120 and the first conveyance device 110. More specifically, a front end 211 of the first FPCB 210 arrives at the first conveyance device 110. Then, the light beams from the first detecting unit 1312 to the second detecting unit 1322 can be interrupted by the transiting first FPCB 210. In this process, the second detecting unit 1322 cannot receive the light beams. Secondly, referring to FIG. 2C, the first FPCB 210 is transferred continuously. As the back end 212 of the first FPCB 210 arrives at the first conveyance device 110, the front end 221 of the sequential second FPCB 220 does not yet enter the transition region. Instead, such moment is the desired starting point of the first measuring unit 1311 and the second measuring unit 1321.

In a second step, the distance between the front end 221 of the second FPCB 220 and the back end 212 of the first FPCB 210 is measured. At the detected starting point, the first measuring unit 1311 and the second measuring unit 1321 cooperate to measure a distance between the front end 221 of the second FPCB 220 and the back end 212 of the first FPCB 210. Referring to FIG. 2D, in the measuring process, the second FPCB 220 is conveyed continuously. As the second FPCB 220 enters the transition region and interrupts the light beams from the first measuring unit 1311 to the second measuring unit 1321, the measuring process is finished. Thus, a measured numerical value of the distance to be measured is obtained. Then, the measured numerical value of the space between the front end 221 and the back end 212 is compared with the numerical value C of the predetermined distance. According to the compared result, the conveying speed v2 of the second conveyance device 120 can be adjusted to keep the measured numerical value for the actual separation distance within and satisfy the requirement of the predetermined distance range. For example, when a numerical value of the measured distance is larger than the numerical value C, even larger than C+1, the conveying speed v2 of the second conveyance device 120 is adjusted to be larger than the conveying speed v1 of the first conveyance device 110, and the adjustment continues until the measured distance is equal to the predetermined distance or within the predetermined distance, as the case may be. When a numerical value of the measured distance is less than the numerical value C, even less than C−1, the conveying speed v2 of the second conveyance device 120 is adjusted less than the conveying speed v1 of the first conveyance device 110, until the measured distance is equal to the predetermined distance or within the predetermined distance range, as the case may be.

In a third step, the first conveyance device 110 conveys the first FPCB 210 to the pressure roller 150 to be laminated. When the first FPCB 210 arrives at the predetermined position of the pressure roller 150, a proper distance is provided between the second FPCB 220 and the first FPCB 210. On the one hand, the second FPCB 220 cannot be so far from the pressure roller 150 that a lot of photo-resist film may be wasted. On the other hand, the second FPCB 220 cannot so near to the first FPCB 210 that it affects or impacts the processing of the first FPCB 210.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A laminator for laminating a film sheet on a respective surface of a plurality of substrates, the laminator comprising:
a pressure roller;
a first conveyance device for controllably conveying substrates to the pressure roller;
a second conveyance device for controllably conveying substrates to the first conveyance device; and
a distance measuring system for measuring a space between a first substrate on the first conveyance device and a sequential substrate on the second conveyance device, the sequential substrate being adjacent to the first substrate.

2. The laminator as claimed in claim 1, wherein the first conveyance device comprises at least a first conveyor roller and at least a first rotational driving element to drive the first conveyor roller.

3. The laminator as claimed in claim 2, wherein the first conveyor roller driven by the first rotational driving element conveys the first substrate with a uniform speed.

4. The laminator as claimed in claim 1, wherein the second conveyance device comprises at least a second conveyor roller and at least a second rotational driving element to drive the second conveyor roller.

5. The laminator as claimed in claim 4, wherein the second conveyor roller driven by the second rotational driving element conveys the second substrate with a variable speed.

6. The laminator as claimed in claim 1, wherein the distance measuring system comprises a driving apparatus to drive the distance measuring system.

7. The laminator as claimed in claim 1, wherein the distance measuring system comprises an emitter and an opposite acceptor, the emitter is arranged opposite the acceptor, the emitter and the acceptor thereby being configured to be directed at opposite sides of a given substrate received therebetween.

8. The laminator as claimed in claim 1, wherein the laminator further comprises a controller for controlling the distance measuring device, the first conveyance device, and the second conveyance device.

9. The laminator as claimed in claim 1, wherein the pressure roller comprises a top pressure roller and an opposite bottom pressure roller, the top pressure roller and the opposite bottom pressure roller being configured for receiving a substrate of the first conveyance device and for thereby laminating the received substrate.

10. A method of laminating a film sheet on a respective surface of a plurality of substrates, the method comprising:
employing a first conveyance device in order to supply substrates to a pressure roller;
employing a second conveyance device in order to convey substrates to the first conveyance device;
establishing a predetermined distance between a first substrate on the first conveyance device and a sequential substrate on the second conveyance device, the sequential substrate being adjacent to the first substrate on the first conveyance device;
using a distance measuring system to measure a distance between the first substrate on the first conveyance device and the sequential substrate on the second conveyance device; and
comparing the measured distance with the predetermined distance, and in accordance to the compared result, employing a controller to control a conveying speed of the second conveyance device to keep an actual distance between the first substrate on the first conveyance device and the sequential substrate on the second conveyance device within the predetermined distance range.

11. The method as claimed in claim 10, wherein the predetermined distance is in a range from about 2 millimeters to about 25 millimeters.

12. The method as claimed in claim 1, wherein an allowable error of the predetermined distance is in a range from about minus one millimeter to about plus one millimeter.

13. The method as claimed in claim 11, wherein an allowable error of the predetermined distance has an absolute value in a range from about 0.15 millimeters to about 1.5 millimeter.

14. The method as claimed in claim 10, wherein the first conveyance device supplies the first substrate to the pressure roller with a uniform speed.

15. The method as claimed in claim 14, wherein the second conveyance device conveys the sequential substrate to the first conveyance device with a variable speed.

16. The method as claimed in claim 15, wherein when a numerical value of the measured distance is larger than the predetermined distance, the conveying speed of the second conveyance device is adjusted by the controller to be larger than the conveying speed of the first conveyance device, until the measured distance is equal to the predetermined distance.

17. The method as claimed in claim 15, wherein when a numerical value of the measured distance is less than the predetermined distance, the conveying speed of the second conveyance device is adjusted by the controller to be less than the conveying speed of the first conveyance device, until the measured distance is equal to the predetermined distance.

18. The method as claimed in claim 10, wherein the conveying speed of the first conveyance device is consistent with a laminating speed of the pressure roller.

19. The method as claimed in claim 10, wherein a detecting process that detects a starting point of the step of measuring the distance between the first substrate and the sequential substrate is performed before measuring the distance between the first substrate on the first conveyance device and the sequential substrate on the second conveyance device.

20. A method of laminating a photo-resist film on a respective surface of a plurality of flexible printed circuit boards (FPCBs), the method comprising:
employing a first conveyance device to supply a first FPCB to a pressure roller, the first FPCB having a front end close to the pressure roller and an opposite back end;
employing a second conveyance device to convey a second FPCB to the first conveyance device, the second FPCB having a front end close to the first FPCB and an opposite back end, the second FPCB being adjacent to the first FPCB;
establishing a predetermined distance range between the front end of the second FPCB and the back end of the first FPCB;
using a distance measuring system to measure a distance between the front end of the second FPCB and the back end of the first FPCB; and
comparing the measured distance with the predetermined distance range, and in accordance to the compared result, employing a controller to control a conveying speed of the second conveyance device to keep a distance between the front end of the second FPCB and the back end of the first FPCB, within the predetermined distance range.
